(19) United States
(12) Patent Application Publication
(10) Pub. No.: US 2020/0311708 A1
(43) Pub. Date: Oct. 1, 2020

(54) SYSTEM AND METHOD FOR PEER TO PEER OFFLINE TRANSACTION

(71) Applicant: Capital One Services, LLC., McLean, VA (US)

(72) Inventors: Sophie BERMUDEZ, Washington, DC (US); Omar Khan, Marriottsville, MD (US); Akbar Hosseinkhani, Burke, VA (US)

(21) Appl. No.: 16/363,343

(22) Filed: Mar. 25, 2019

(51) Int. Cl. G06Q 20/22; G06Q 20/32; H04W 4/80

(52) U.S. Cl. CPC G06Q 20/223; G06Q 20/3224; H04W 4/80; G06Q 20/3278

(57) ABSTRACT

Embodiments of systems and methods for peer to peer offline transactions are described. The systems and methods may allow for the secure offline transfer of information or transactions between users possessing transfer devices. The transferred information or monetary value may be immediately available once transferred without the need for a central agent to verify and approve of the transfer. Embodiments of the systems and methods may allow for the synchronization of the offline records between transfer devices with a central server using a carrier device, where the carrier device may act as an intermediary between the server and the transfer devices.

### FIELD OF THE INVENTION

This disclosure relates to peer to peer offline transactions, and more specifically, to systems and methods for the secure transfer of information offline.

### BACKGROUND

Banking and accounting are central parts of any economy. Traditional systems of transferring money in a banking system rely on the availability of a bank to coordinate the transfer of funds between two individuals with the bank acting as an intermediary. These systems require the bank to be available at the time of the transaction. If a bank or other central agent is not available, the transfer of funds is not secure, and the recipient cannot verify that the funds are in fact available to, and sent by, the sender. Accordingly, the ability to securely transfer funds between individuals, without waiting for a central agent to clear the funds as in a traditional system, has not been implemented.

Although the availability of data communication networks, such as the internet, has in many parts of the world addressed the problem of transferring funds and made it quicker compared to traditional checks, the method still relies on a central agent to clear the funds transfer request. Further, without the availability of the internet as the medium of communication of such requests, such requests would not be possible.

### SUMMARY

Therefore, it is an object of this disclosure to describe a system and method for securely transferring information, whether credits, money, or other information, between individuals, without waiting for a central agency and potentially without immediate access to the internet or other data communication network.

Embodiments of the present disclosure provide a system for the secure exchange of information between devices, comprising a transfer device containing at least a microprocessor, a contactless communication interface having a transfer device communication field, and a memory, wherein the memory stores a first user identifier; and, a carrier device containing at least a microprocessor, a contactless communication interface having a carrier device communication field, and a memory, wherein the memory stores a second user identifier; and a server containing a microprocessor and a database storing user identifiers associated with each of the at least one transfer devices; wherein upon initiation of an information exchange by the transfer device, the microprocessor of the transfer device is configured to create a data record in the memory of the transfer device relating to the information exchange, the data record containing the information exchanged, the first user identifier, and a second user identifier associated with a second transfer device, wherein, upon overlap of the transfer device communication field and the carrier device communication field, the transfer device and the carrier device are configured to synchronize and store any data records containing the first user identifier, and wherein, upon engaging in data communication with the server, the carrier device is configured to synchronize any data records with the server.

Embodiments of the present disclosure provide a method for the secure exchange of information between devices, the method comprising modifying a data record stored in a first transfer device, the first transfer device containing a microprocessor, a contactless communication interface having a first transfer device communication field, and memory; initiating, by the first transfer device, the transfer of the data record to a second transfer device, the second transfer device containing a microprocessor, a contactless communication interface having a second transfer device communication field, and memory; transmitting the modified data record from first transfer device to a carrier device containing a microprocessor, a contactless communication interface having a carrier device communication field, and memory, when the first transfer device communication field and the carrier device communication field overlap; updating the carrier device memory with the data record received from the first transfer device; and transmitting, by the carrier device, the data record to the server.

Embodiments of the present disclosure provide a carrier device comprising at least a microprocessor, a contactless communication interface having a carrier device communication field, and a memory, wherein the carrier device is configured to communicate with a plurality of transfer devices, each transfer device identified by unique user identifiers and contactless communication interfaces having transfer device communication fields; synchronize data records with one of the plurality of transfer device when the carrier device communication field overlaps with the transfer device communication field; synchronize data records with a server; and communicate with a server to receive and send current and predicted location information.

### BRIEF DESCRIPTION OF THE DRAWINGS

FIG. 1A illustrates an example embodiment of a transfer device.

FIG. 1B illustrates an example embodiment of processing circuitry of the transfer device of FIG. 1A.

FIG. 2A illustrates an example embodiment of a carrier device.

FIG. 2B illustrates an example embodiment of processing circuitry of the carrier device of FIG. 2A.

FIG. 3 illustrates an example embodiment of a method for the secure transfer of information between two transfer devices.

FIG. 4 illustrates an example embodiment of a method for the secure transfer of information between a transfer devices and a carrier device.

FIG. 5 illustrates an example embodiment of a server.

FIG. 6 illustrates an example embodiment of a carrier device and server communication system for synchronization of information.

FIG. 7 illustrates an example embodiment of a system for the synchronization of information.

### DETAILED DESCRIPTION

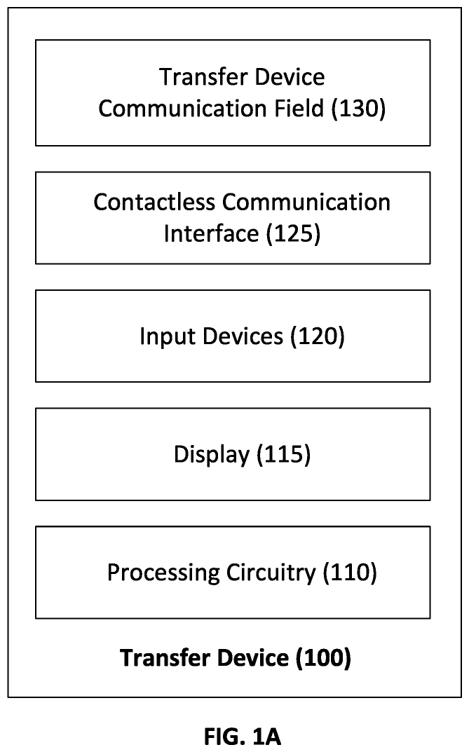

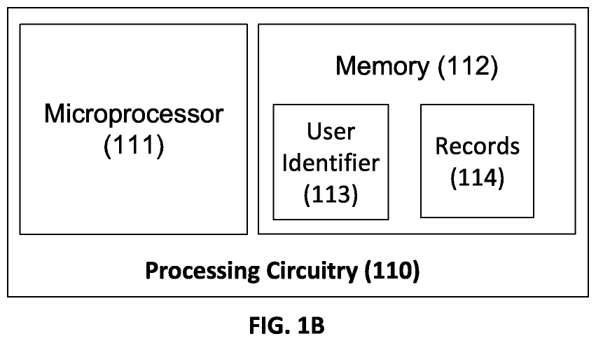

FIG. 1A illustrates a transfer device 100 according to an example embodiment. The transfer device may be carried by a user who wishes to send or receive information from another user. The transfer device 100 may be a mobile device or smartphone. In other embodiments, the transfer device may be a laptop or a personal computer. However, the transfer device may be any computing device capable of storing, sending, and receiving data.

The transfer device may contain processing circuitry 110, a contactless communication interface 125, a transfer device communication field 130. The contactless communication interface 125 may be of any suitable technology capable of sending or receiving data over a distance. Examples of such technology include, for example, Wi-Fi, WLAN, RF, radio, IR, and Bluetooth, or any combination thereof or any other appropriate architecture or system that facilitates the communication of signals, data, and/or messages. Similarly, any suitable hardware level and software level algorithm may be chosen to allow for the transfer of data on the transfer device communication field 130. Examples of algorithms that may be the asynchronous connection-less protocol, synchronous connection-oriented link, link management protocol, host controller interface, or low energy link layer.

In an embodiment, the transfer device may contain a display 115 and input devices 120. The display 115 may be selected from any suitable two-dimensional or three-dimensional display, such as a light-emitting diode, liquid crystal display, digital light processing display, or organic light-emitting diode display. The user interface may be selected from any suitable user input device such as a touchpad, a touchscreen, a mechanical switch, natural language user interface, a click-wheel, QWERTY keyboard, mouse, gesture recognition, or capacitive touchscreen.

FIG. 1B illustrates the components of the processing circuitry 110 according to an example embodiment. The processing circuitry 110 may include a microprocessor 111 and a memory 112. It is understood that the processing circuitry may contain additional components, including processors, memories, error and parity/CRC checkers, data encoders, anticollision algorithms, controllers, command decoders, security primitives and tamperproofing hardware, as necessary to perform the functions described herein.

The memory 112 may be a read-only memory, write-once read-multiple memory or read/write memory, e.g., RAM, ROM and EEPROM, and a transfer device 100 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 112 may store at a user identifier 113 and data in the form of records 114. The memory 112 may be divided into several zones, with each zone having a different level of security. The microprocessor 111 may keep track of which memory addresses belong to which zones and the circumstances under which each zone may be accessed. In an example embodiment, the memory 112 may be divided into four zones: a secret zone, a confidential zone, a usage zone, and a public zone.

A secret zone may be used for storage of information which may be used only by the microprocessor 111, e.g., passwords, cryptographic keys. The information stored in this zone is not readable outside of the transfer device. The zone may also contain a dynamic algorithm which determines the amount of money that may be transferred by a transfer device. In an embodiment, the secret zone may be implemented with a separate processor that is capable of performing cryptographic functions. Cryptographic keys may be passed in to the secret zone or may be generated in the secret zone, and in either case the keys may be stored in the secret zone and used to support cryptographic services. If necessary, cryptographic keys may be exported from the secret zone.

A confidential zone may be used to store a list of all transactions made with the card. The confidential zone may have password protection. In an example embodiment, the password is known only to the financial institution, which may examine the history of the transfer device for evidence of misuse of the system. The confidential zone may have a read-only access restriction so that the information stored in this zone could not be modified by the user, e.g., the transfer list could not be modified.

A usage zone could be used for storage of information which may be periodically updated or modified. Depending on the sensitivity of the data, a password may be implemented for this zone. The usage zone may have both read and write access protected by a password. In an embodiment, the usage zone could keep a list of the most recent transfers made by the device and include additional data about those transfers, such as the time, place, and hardware ID of the device to which the transfer was made.

A public zone may be used for keeping less sensitive information, such as the transfer device user's name and the amount of funds available to transfer.

It is understood that the assignment of data to security zones is not limited in the examples described above, and the present disclosure provides for different assignments of data based on data sensitive and the needs of the transaction.

The user identifier 113 may be a digital identifier that identifies a user who possesses a transfer device. The user identifier 113 may correspond to one or more financial accounts the user possesses with a financial institution. This identifier will be specific to the user and corresponds to the user's account on the financial institution's servers, as described infra. In an example embodiment, the user identifier may be stored in the secret zone of the memory 112.

In an example embodiment, a record 114 stored on memory 112 may store the amount of money transferred, the time of transfer, and the user identifier associated with the transfer device to which the money was received from or transferred to. Additionally, the record 114 may contain additional information, such as the hardware profile of the transfer devices involved in the transfer, the type of transfer device communication field, and the GPS location of the transfer.

Further, based on constraints set by the financial institution, this identifier may modify the behavior of the information that the transfer device may transfer. For example, the user identifier may contain additional information or logic allowing it to transfer higher priority data. As another example, the user identifier may encode the types of financial accounts that the user possesses, and the amounts of money that the transfer device is able to transfer. In an embodiment, if a user has a business account for a long period of time with a financial institution, this information may be contained in the digital identifier and may allow the transfer device to send a higher sum of money from the transferor or sender to a transferee or receiver compared to another user that may have had a personal account for a short period of time.

In another embodiment, the user identifier 113 may only be written into memory when the transfer device is originally setup into read-only memory. One-time programmability provides the opportunity to write once then read many times. This may also provide additional security to prevent tampering of sensitive information included on the transfer device.

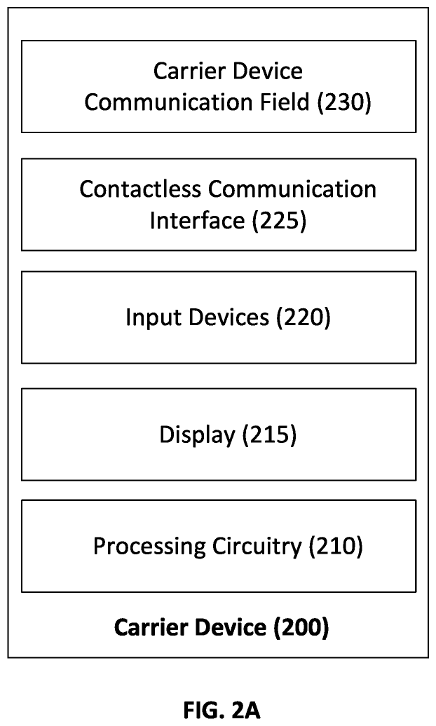

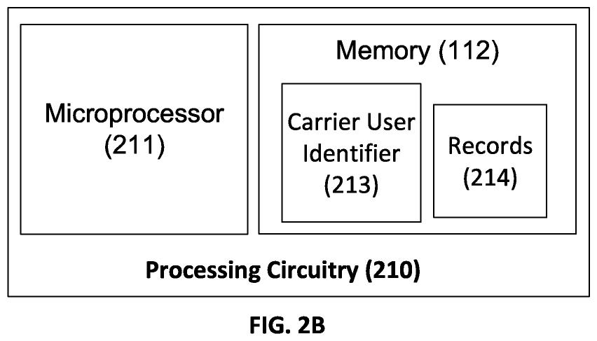

FIG. 2A illustrates an exemplary carrier device, which is intended to be carrier by individuals who wish to act as intermediaries of information. Carrier devices may also be transfer devices, however, it is understood that a carrier device may have additional capabilities not present in a transfer device. In an embodiment, the carrier device 200 may be a mobile device such as a smartphone. In other embodiments, the carrier device may be a laptop or a personal computer. However, the transfer device may be any computing device capable of storing, sending, and receiving data.

The transfer device may contain processing circuitry 210, a contactless communication interface 225, and a transfer device communication field 230. Like the transfer device and without limitation, these components may be chosen from any suitable class of components. In this embodiment, the carrier device may contain a display 215 and input devices 220. The display 215 may be selected from any suitable two-dimensional or three-dimensional display, such as a light-emitting diode, liquid crystal display, digital light processing display, or organic light-emitting diode display. The user interface may be selected from any suitable user input device such as a touchpad, a touchscreen, a mechanical switch, natural language user interface, a click-wheel, QWERTY keyboard, mouse, gesture recognition, or capacitive touchscreen.

FIG. 2B illustrates the components of the processing circuitry 210. The processing circuitry 210 may include a microprocessor 211 and a memory 212. It is understood that the processing circuitry may contain additional components, including processors, memories, error and parity/CRC checkers, data encoders, anticollision algorithms, controllers, command decoders, security primitives and tamperproofing hardware, as necessary to perform the functions described herein.

The memory 212 may be a read-only memory, write-once read-multiple memory or read/write memory, e.g., RAM, ROM and EEPROM, and a carrier device 200 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 212 may store at a first carrier user identifier 213 and data in the form of records 214. The memory 212 may be divided into several zones, with each zone having a different level of security. The microprocessor 211 may keep track of which memory addresses belong to which zones and the circumstances under which each zone may be accessed. In an example embodiment, the memory 212 may be divided into four zones: a secret zone, a confidential zone, a usage zone, and a public zone.

A secret zone may be used for storage of information which may be used only by the microprocessor 211, e.g., passwords or cryptographic keys. The information stored in this zone is not readable outside of the carrier device.

The public zone may also be divided into additional zones. For instance, one zone could be dedicated to information that the carrier device obtains from transfer devices while another zone is reserved for records that the carrier device obtains from the server of the financial institution.

It is understood that the assignment of data is not limited to the examples described above, and the present disclosure provides for different zones and assignments of data based on data sensitive and the needs of the transaction.

The memory may also include a carrier user identifier 213 and records 214. The carrier user identifier 213 may be of a different category than the user identifier 113 and may in conjunction with the memory 212 and microprocessor 211, provide additional functionality to the carrier device.

In an embodiment, the memory 212 may be sufficiently large in order to carry records of transfers that have taken place on behalf of a plurality of transferors. In an embodiment, the records 214 stored on the memory 212 of the carrier device would not only contain the information contained in the record is transferred into the carrier device from a transfer device, but, additional meta-data related to the transfer to the carrier device.

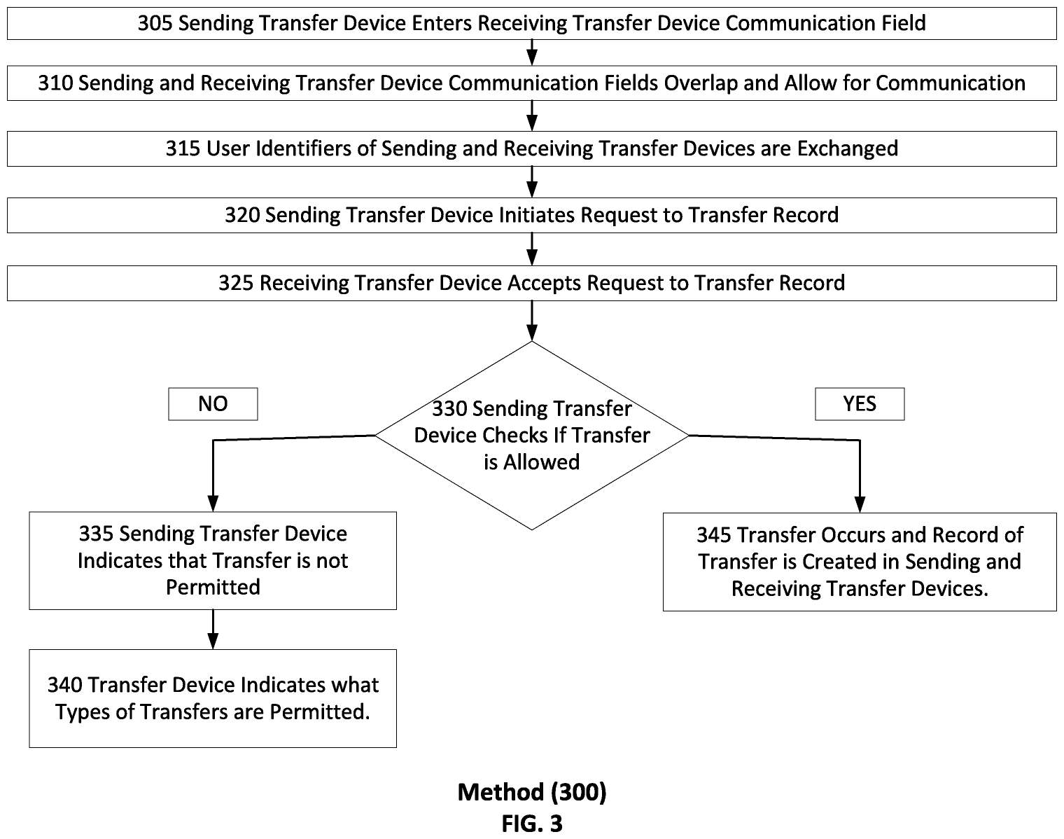

FIG. 3 is a flow chart diagramming a method of transferring information and creating a record of the transfer from one transfer device to another according to an example embodiment. The secure intra-transfer-device transfer method commences at step 305, when a sending transfer device enters a receiving transfer device's transfer device communication field. In step 310, the sending and receiving transfer devices recognize that there is an overlap of the communication fields and the processing circuitry of the devices allows for the exchange of information. In step 315, the user identifier of the sending transfer device and the receiving transfer device are exchanged between the devices in order for the devices to recognize that an exchange of information is intended. Thereafter, in step 320, the sending transfer device initiates a request to transfer a record. This may be done through the display 115 and inputs devices 120 described supra. Following step 320, in step 325, the receiving transfer device accepts the request to transfer a record. Following step 330, the processing circuitry of both devices may check whether the type transfer is permitted. In an example embodiment, this information may be stored in the secret zone of the memory 112. If the type of transfer is not permitted, the sending transfer device will indicate that the transfer is not permitted in step 335. In step 340, either transfer device may indicate what types of transfer are permitted. If the transfer is permitted, then, the transfer occurs in step 345. In step 345, the transfer occurs and a record of the transfer is created in both the sending transfer device and the receiving transfer device. In an example embodiment, the sum of money transferred will be immediately usable by the receiver or transferee to further engage in commerce with other transfer devices.

In an embodiment, the request may contain information about the amount of money to be requested and when the money would be accessible. In other example embodiments, different information may be transferred, such as the exchange of currency in different denominations, electronic media such as videos, text files, PDFs, or music, or other digital information.

In another example embodiment, the records sent between the sending transfer device and the receiving transfer device may be encrypted. Encryption of information is generally undertaken to ensure privacy and so that no one other than the intended recipient may decrypt the information. Encryption is also undertaken to ensure the authenticity of the information, that is, that a message which purports to originate with a particular source actually does so and has not been tampered with. Encryption may be done with any suitable algorithm. Encryption methods known in the art include Advanced Encryption Standard, Triple Data Encryption Standard, Twofish, RSA, and public-key cryptography.

Additionally, the behavior of the transfer may be greatly modified by the stored user identifiers within either one or both transfer devices involved in the transfer of information. For example, the user identifier could encode information that prevents information from being sent and only received. In this manner, by means of the user identifiers, the central server is still able to modify and control the transfer of information between the devices despite being offline.

Further, the microprocessor 111 and memory 112 of the transfer device may contain additional logic which further modifies the transfer of information. For instance, the logic may limit the number of transfers that a transfer device may perform within a period of time. As another example, the logic may only allow the transfer of information to occur to a certain amount of types of information. In the financial context, this may mean only allowing the transfer of information between certain accounts of the transferor, or only up to a certain monetary value. Preferably, each transaction is evaluated based on a risk profile of the transfer and only allowed when the risk of the transaction is below the calculated risk profile of the transaction to prevent a user from being overdrawn on his account. For instance, factors that may be considered include, but are not limited to: payment history, history of overdraft, length of accounts, types of accounts, other financial instruments, credit score, frequency of transfers, credit worthiness of transferor or transferee, and time of last synchronization with a server or carrier device. A financial institution may also choose which algorithm to implement based on the user identifier associated with the transfer device and give different weights for the various parameters being considered. This method allows for flexibility. A choice of algorithm may be tailored as desired by a financial institution. In an example embodiment, the algorithm may use simple parametric statistical method, simple Bayes classifiers, nonparametric statistical methods, classification trees, and neural network technology for credit scoring applications.

Additionally, as transfer devices are contemplated to both send and receive offline payments, in another example embodiment, funds received from a transfer device with a lower trust rating could be discounted by a factor based on the risk profile of the transfer. Thus, the receiving transfer device would only have access to a portion of the funds available. This would prevent network effects of risk transactions accumulating in the network when a long period between synchronization with a server has occurred.

In an example embodiment, if a transfer is not permitted, the record or data intended to be transferred by a transfer device may be nullified, destroyed, or voided, as appropriate, to prevent any further attempts by the transfer device to transfer records. In one example, a transfer may not be permitted after a certain number of days have transpired from the last time a transfer device has synchronized with a carrier device. In another example, the transfer can be prevented based on a certain number of transfers already occurring within a pre-determined time period. In another example, the record or information on the transfer device can be nullified, destroyed, or voided upon receiving information associated with the user identifier stored on the transfer device via a carrier device. In an example embodiment, only certain records or data may selectively be nullified, destroyed, or voided on the device. For instance, records created in the transfer device by exchange with certain transfer devices, identified through their associated user identifiers, may be nullified, destroyed, or voided. In another instance, records of transfers of having a monetary value above a certain amount may be destroyed, while records of transfers having a monetary value below a certain amount may be preserved. In another embodiment, records that have been transferred above a certain number of times between transfer devices may be locked or nullified from future transfers until certain conditions are met, such as for example, synchronization with a carrier device.

Additionally, the rules associated with the user identifiers need not be static. As explained further infra, the carrier device may update the information associated with the transfer device.

Further, a record of the transfer is preferably recorded in both the transferor's transfer device and the transferee's transfer device. This provides several benefits. One is allowing for verification of transaction by two parties. Another is in case of the destruction of one of the devices, a redundant record remains in the other device. In another embodiment, the record of the transfer, by choice of the transferor, may even be stored by other transfer devices to increase redundancy. This helps mitigates instances in which when both devices are destroyed, the record of the transfer disappears and is never synced with the server.

It is understood that any suitable encryption method may be used to encrypt the records on the transfer devices.

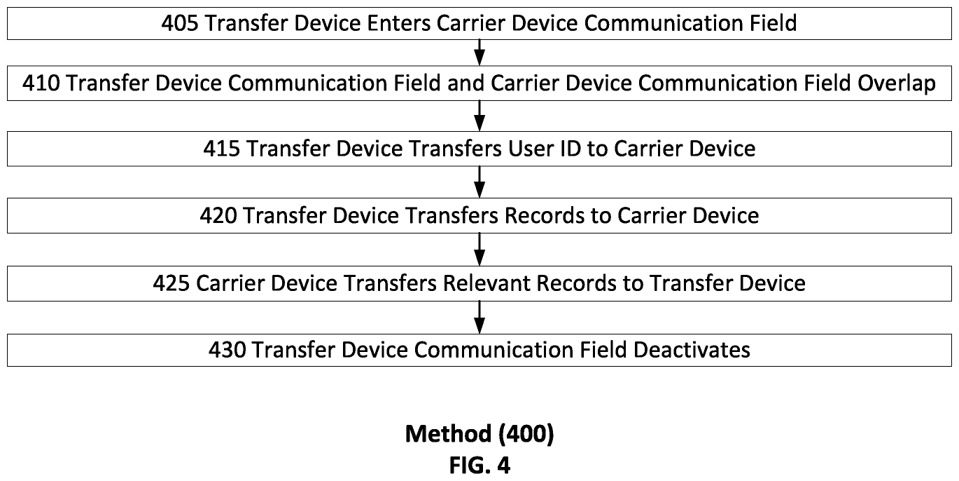

FIG. 4 illustrates an example embodiment of a method for the secure transfer of information between a transfer device and a carrier device. The method begins at step 405, when a transfer device enters the carrier device communication field. In step 410, if the transfer device communication field is active, the transfer device communication field and the carrier device communication field overlap, allowing for the capability of exchanging information between the transfer device and a carrier device. In step 415, the transfer device transfers its user identifier to the carrier device. This allows for the carrier device to recognize if it possesses a current record of the user identifier in its memory. In step 420, the transfer device transfers the records it contains in its memory to the carrier device. These records may be records of the transfers that occurred as described in FIG. 3 between a transferor's transfer device and a transferee's transfer device. In step 425, the carrier device transfers any records relevant to the user identifier of the transfer device it is in communication with to the transfer device. This information may include for example, updated financial information about the financial accounts associated with the said user identifier, such as an updated balance. After the records have been exchanged, the transfer device communication field deactivates in step 430.

In an embodiment, when there is overlap between the transfer device communication field and the carrier device transfer device, the records stored within the transfer device should automatically transfer to the carrier device. In another exemplary embodiment, the information transferred may at a minimum contain information about the user identifiers associated with the two transfer devices involved in the original transfer, the record transferred between those two devices, the user identifier of the device transferring the information to the carrier device, and the time of the transfer. Additional information, such as the hardware, GPS location, medium of communication for the communication fields, may all be stored. Additionally, a record of the communication being established between the transfer device and may also be created in the transfer device. This record may be used as an input in evaluating the level of trust, described supra.

In an embodiment, the carrier device may always have an active carrier device field, to allow the carrier to always receive records as the carrier is moving. In an embodiment, the carrier device could have multiple contactless communication interfaces, allowing the carrier to interface with transfer devices over a variety of technologies.

Multiple carrier devices could also carry the same transfer records described above, which provides advantages for redundancy in case any of the devices are destroyed.

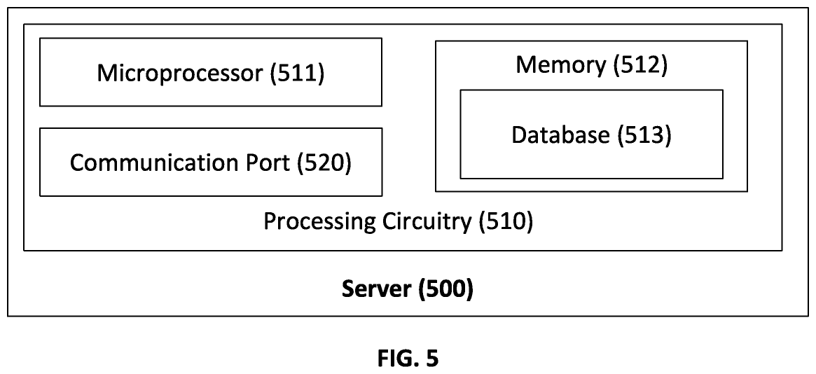

FIG. 5 illustrates a server 500 according to an example embodiment. The server may contain processing circuitry 510. The processing circuitry 510 may contain a microprocessor 511 and memory 512. The memory may contain a database 513. The database 513 may be a relational or non-relational database, and may contain a list of user identifiers and associated financial information related to those user identifiers. The server may also contain a communication port 520. The communication port 520 may allow for both wired and wireless transmission of information. A carrier device may synchronize with the server through this communication port. One method would be a physical connection, such as a USB, Firewire, or Ethernet. Other methods of transferring data, such as wireless communication, described supra, are alternative embodiments to achieve synchronization. In an embodiment, the server is a physical device at a financial institution, such as an Automated Teller Machine. The server could also be a physical device dedicated for the purpose of synchronizing with carrier devices.

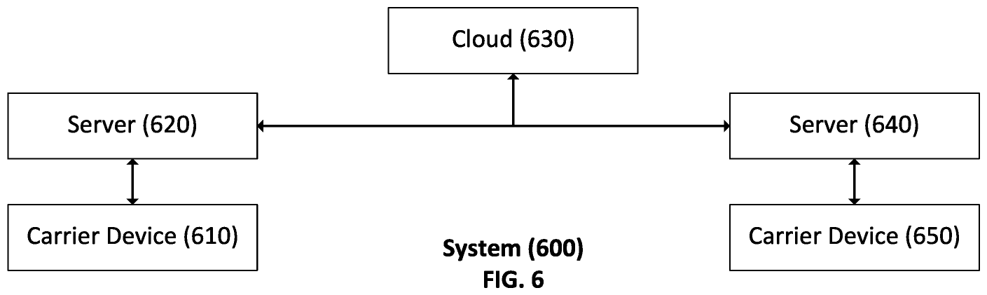

FIG. 6 illustrates an exemplary system which allows the synchronization of information between various servers and carrier devices. The system may consist of at least two servers, 620 and 640, and a central database or cloud 630 containing information of all user identifiers that belong to the financial institution. When a carrier device, such as 610, communicates with one server, the information is updated in the central database or cloud 630, and propagated to other servers. This may allow carrier devices that are geographically restricted to accessing only certain servers to obtain the most up to date information associated with user identifiers. Thus, carrier device 650, which may be at a geographical distance from sever 620, is able to receive the most up to date records associated with a user identifier.

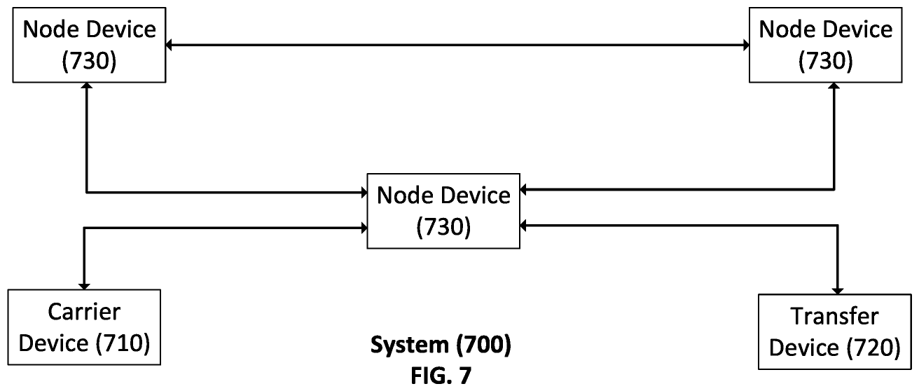

FIG. 7 illustrates an exemplary system which allows for the synchronization of information between devices in a mesh peer to peer network. System 700 can consist of at least a carrier device 710 and a transfer device 720. Carrier device 710 and transfer device 720 can communicate with one another to transfer information of the type described above, including for example, information about balances, a list of transactions taken by a user, information about debits and credits, or information about pending transactions. System 700 can also consist of another device, such as node device 730, which can be any device capable of receiving and sending information to and from both carrier device 710 and transfer device 720. Node device 730 can also be a transportation vehicle that carries the capabilities of receiving and sending information described above. For example, the node device 730 can be a blimp, a truck a van, an aircraft, an amphibious vehicle, a bicycle, a barge, a boat, a biplane, a train, an electric car, a smart device, a router, or a cell phone tower or a drone. The node devices can thus be mobile allowing for communication and connectivity in remote areas.

Communication within system 700 can occur using any of the methods described above, including for example, Bluetooth, NFC, and wireless communication. Carrier device 710, transfer device 720, and node device 730 can all further have the necessary software and hardware configuration to allow for the communication, storage, and dissemination capabilities described above. The mesh network can either be a fixed network, wherein the nodes can consist of a partially fixed set of hardware, such as for example, permanent node devices, or can be a mobile mesh network, wherein the nodes of the network are movable or mutable.

In an example embodiment, node device 730 can be an automatic teller machine (ATM), or other financial machine which can act as a node in the de-centralized network. Node device 730 can in one embodiment, as an ATM can be connected to other node devices 730 on a dedicated network which allows for information obtained or synced at one ATM to be available at another ATM. Thus, node device 730 can be part of a fixed mesh network wherein the node devices act as a consistent hardware node to provide synchronization across a known set of devices.

In another example embodiment, system 700 can thus be a de-centralized network in which there is no centralized server that stores the information which may be contained on a transfer device or a carrier device. In this manner, several transfer devices and/or carrier devices can create a decentralized peer to peer network in which information is passed between various devices. In an example embodiment, the decentralized network can be a mesh network in which the transfer device, the carrier device, and node device act as nodes of the network. The various nodes can connect with each other directly, and dynamically cooperate with one another, to route data as required between the nodes. The data communication links between the nodes can also be dynamic, and use any of the technologies, or equivalents, described above to act as the medium to cause the information to be transferred. In an example embodiment, during the synchronization, the carrier device will transfer to the server the records and associated user identifiers to the server. The server will then use this information to update the server-side information related to the accounts associated with respective user identifiers. A record of the synchronization may also be created in the server. In addition, the server may provide updated information regarding the accounts associated with the respective user identifiers. For instance, if additional funds were deposited in an account associated with a user identifier, and this information was not yet available on the transfer device, this updated information may be transferred to the carrier device.

In an embodiment, the server credits the carrier device for the transfer records synchronized with the server. The amount of credit may be based on, for example, the number of records, the monetary value of the records, the time it took for each record to be transferred, or on an algorithm based on these and other parameters. In an exemplary embodiment, a carrier device may receive additional credits for more frequent synchronizations or achieving a target number of synchronizations.

In an embodiment, the server may, based on a locale that the carrier device is intended to be carried to, transfer information based on the storage capacity of the carrier device and transfer devices the carrier device is likely to encounter.

In an embodiment, the server may, based on which transfer devices the carrier most frequently communicates with, optimize the set of records to be synchronized with the carrier device for exchange with transfer devices.

In an embodiment, the server may, based on the prior GPS location of the carrier device, use a linear or non-linear optimization method, such as Dijkstra's algorithm, to optimize the set of records to be synchronized with the carrier device. An algorithm based on a custom design or based on a known subfield of mathematics, such as convex programming, linear programming, integer programming, stochastic programming, combinatorial optimization, stochastic optimization. Even fields studying the optimization in dynamic contexts, such as calculus of variations may be used.

In an embodiment, the server may inform the carrier of a location where the average time of synchronization for transfer devices has been higher than average for the system and provide additional incentives for a carrier device to communication in those areas.

In addition to the above described capability, a person skilled in the art would understand that additional capabilities may be incorporated into the devices and methods described herein. For example, if a suitable time has passed between the transfer, or the carrier device verifies that the last record has been synchronized with the server, older records may be deleted from the transfer device.

The present disclosure is not to be limited in terms of the particular embodiments described in this application, which are intended as illustrations of various aspects. Many modifications and variations may be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

1. A system for the secure exchange of information between devices, comprising:
a transfer device containing at least a microprocessor, a contactless communication interface having a transfer device communication field, and a memory, wherein the memory stores a first user identifier comprising:
a user identification corresponding to an account having an account opening date, and
logic, wherein the logic establishes a transfer amount limit and a transfer number limit; and,
a carrier device containing at least a microprocessor, a contactless communication interface having a carrier device communication field, and a memory, wherein the memory stores a carrier user identifier; and
a server containing a microprocessor and a database storing user identifiers associated with the transfer device and a plurality of other transfer devices;
wherein upon initiation of an information exchange by the transfer device, the microprocessor of the transfer device is configured to create a data record in the memory of the transfer device relating to the information exchange, the data record containing the information exchanged, the first user identifier, and a second user identifier associated with a second transfer device,
wherein, upon overlap of the transfer device communication field and the carrier device communication field, the transfer device and the carrier device are configured to synchronize and store any data records containing the first user identifier,
wherein, upon engaging in data communication with the server, the carrier device is configured to synchronize any data records with the server, and
wherein, the server is configured to:
receive location information related to the carrier device and to the transfer device, and
transmit, to the carrier device, location information and a data record related to the transfer device if the server determines that the transfer device is within a set geographic proximity to the carrier device.

2. The system for the secure exchange of information between devices of claim 1, wherein the server is replaced with a mesh network wherein the mesh network consists of at least one of the carrier device and one of the transfer device.

3. The system of claim 2 wherein the mesh network includes one or more nodes, wherein the nodes are selected from one or more of a transportation device, a vehicle, a smart device, an ATM, or a bank.

4. The system for the secure exchange of information between devices of claim 1, wherein the data records relate to a financial transaction and wherein the financial transaction is limited based on the first user identifier.

5. The system for the secure exchange of information between devices of claim 1, wherein the carrier device receives a credit upon synchronizing the data record with the server.

6. The system for the secure exchange of information between devices of claim 1, wherein the server records location information related to the carrier device.

7. The system for the secure exchange of information between devices of claim 6, wherein:
the transfer device stores location information in the data record, and
the server records the location information stored in the data record.

8. (canceled)

9. The system for the secure exchange of information between devices of claim 6 wherein the server selects data records to synchronize with the carrier device based upon the location history of the carrier device.

10. The system for the secure exchange of information between devices of claim 6 wherein the server selects data records to synchronize with the carrier device based upon the predicted location of the carrier device.

11. The system for the secure exchange of information between devices of claim 5 wherein:
the carrier device transmits to the server information relating to a geographic area the carrier device will enter, and
the server synchronizes information related to one or more transfer devices in the geographic area.

12. A method for the secure exchange of information between devices, the method comprising:
modifying a data record stored in a first transfer device, the first transfer device containing a microprocessor, a contactless communication interface having a first transfer device communication field, and memory;
initiating, by the first transfer device, the transfer of the data record to a second transfer device, the second transfer device containing a microprocessor, a contactless communication interface having a second transfer device communication field, and memory;
transmitting the modified data record from first transfer device to a carrier device containing a microprocessor, a contactless communication interface having a carrier device communication field, and memory, when the first transfer device communication field and the carrier device communication field overlap;
updating the carrier device memory with the data record received from the first transfer device; and
transmitting, by the carrier device, the data record to the server.

13. The method for the secure exchange of information between devices of claim 12,
wherein the data record relates to financial information.

14. The method for the secure exchange of information between devices of claim 12,
wherein the carrier device receives a credit upon transmitting the data record to the server.

15. The method for the secure exchange of information between devices of claim 12, further comprising limiting the data records synchronized between the transfer device and the carrier device to data records created after the transfer device's most recent synchronization with any carrier device.

16. The method for the secure exchange of information between devices of claim 12, further comprising:
storing, by the transfer device, location information in the data record; and
synchronizing, by the carrier device, the data record with the server.

17. The method for the secure exchange of information between devices of claim 16, further comprising:
selecting, by the server, a second carrier device based on the location information contained in the data record, and
transmitting, by the server, the data record to the second carrier device.

18. The method for the secure exchange of information between devices of claim 16, further comprising:
transmitting, by the carrier device, location information to the server, and
selecting, by the server, a second carrier device based on a location history of the second carrier device, and
transmitting, by the server, the data record to the second carrier device.

19. The method for the secure exchange of information between devices of claim 16, further comprising:
transmitting, by the carrier device, location information to the server, and
selecting, by the server, a second carrier device based on a predicted location of the second carrier device, and
transmitting, by the server, the data record to the second carrier device.

20. A carrier device comprising:
at least a microprocessor, a contactless communication interface having a carrier device communication field, and a memory,
wherein the carrier device is configured to:
communicate with a plurality of transfer devices, each transfer device identified by unique user identifiers and contactless communication interfaces having transfer device communication fields, wherein each of the unique user identifiers comprises:
a user identification corresponding to an account having an account opening date, and
logic, wherein the logic establishes a transfer amount limit and a transfer number limit;
synchronize data records with one of the plurality of transfer device when the carrier device communication field overlaps with the transfer device communication field;
synchronize data records with a server;
communicate with a server to receive and send current and predicted location information; and
receive, from the server, a data record related to the one of the plurality of transfer devices if that transfer device is within a set geographic proximity to the carrier device.

21. The system for the secure exchange of information between devices of claim 1, wherein the transfer amount limit restricts the first user identifier to a transfer amount based on the length of time since the account opening date.

22. The system for the secure exchange of information between devices of claim 21, wherein the transfer amount limit increases as the length of time increases.

23. The system for the secure exchange of information between devices of claim 1, wherein the transfer number limit restricts the first user identifier to a number of permissible transfers within a time period.

24. The system for the secure exchange of information between devices of claim 1, wherein the logic further establishes a transfer type limit restrict transfers to one or more types of accounts.

25. The transfer device of claim 20, wherein the transfer amount limit restricts the first user identifier to a transfer amount based on the length of time since the account opening date.

26. The transfer device of claim 25, wherein the transfer amount limit increases as the length of time increases.

27. The transfer device of claim 20, wherein the transfer number limit restricts the first user identifier to a number of permissible transfers within a time period.

28. The transfer device of claim 20, wherein the logic further establishes a transfer type limit restrict transfers to one or more types of accounts.
